(19) United States
(12) Patent Application Publication
(10) Pub. No.: US 2009/0160077 A1
(43) Pub. Date: Jun. 25, 2009

(54) AQUEOUS BINDER FOR FIBROUS OR GRANULAR SUBSTRATES

(75) Inventors: Francesca AULENTA, Mannheim (DE); Markus Braun, Heidelberg (DE); Amold Schneller, Seeheim-Jugenheim (DE); Rainer Dyllick-Brenzinger, Neustadt (DE); Kathrin Michl, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/336,969

(22) Filed: Dec. 17, 2008

(30) Foreign Application Priority Data
Dec. 19, 2007 (EP) 07024635.0

(51) Int. Cl. B29C 67/00; C08L 33/02; C08L 33/08; C08L 35/00; C08L 39/00

(52) U.S. Cl. 264/119; 525/221; 525/223; 525/207; 525/217

(57) ABSTRACT

Aqueous binders for fibrous and granular substrates, based on itaconic acid copolymers.

The subject matter of the present invention relates to an aqueous binder for fibrous and/or granular substrates comprising as active constituents

a) an addition polymer A composed of

| | |
|---|---|
| 0.1% to 70% by weight | of itaconic acid, itaconic anhydride and/or |
| | itaconic acid alkyl ester (monomer A1), and |
| 30% to 99.9% by weight | of at least one further ethylenically unsaturated |
| | monomer (monomer A2) free-radically |
| | copolymerizable with the monomer A1 |

in copolymerized form, the monomers A1 and A2 adding up to 100% by weight (total monomer amount), and
   b) a polyol B having at least 2 hydroxyl groups.

Subject matter of the present invention is likewise the use of the aqueous binder for producing shaped articles, a process for producing shaped articles using fibrous or granular substrates and aqueous binder, and also the shaped articles themselves.

The consolidation of fibrous or granular substrates, more particularly in sheetlike structures, exemplified by fiber webs, fiberboard or chipboard panels, etc., is frequently accomplished chemically using a polymeric binder. To increase the strength, particularly the wet strength and thermal stability, in many cases binders are used which comprise crosslinkers that give off formaldehyde. As a consequence of this, however, there is a risk of unwanted formaldehyde emission.

For the purpose of avoiding formaldehyde emissions there have already been numerous alternatives proposed to the binders known to date. For instance U.S. Pat. No. 4,076,917 discloses binders which comprise carboxylic acid-containing or carboxylic anhydride-containing polymers and β-hydroxyalkylamide crosslinkers. A disadvantage is the relatively costly and inconvenient preparation of the β-hydroxyalkylamides.

EP-A 445578 discloses boards made of finely divided materials, such as glass fibers, for example, in which mixtures of high molecular weight polycarboxylic acids and polyhydric alcohols, alkanolamines, or polyfunctional amines act as binders.

EP-A 583086 discloses formaldehyde-free aqueous binders for producing fiber webs, more particularly glass fiber webs. The binders comprise a polycarboxylic acid having at least two carboxylic acid groups and also, if appropriate, anhydride groups, and a polyol. These binders require a phosphorus reaction accelerant in order to attain sufficient strengths on the part of the glass fiber webs. It is noted that the presence of such a reaction accelerant is vital unless a highly reactive polyol is used. Highly reactive polyols specified include β-hydroxyalkylamides.

EP-A 651088 describes corresponding binders for substrates made from cellulosic fiber. These binders necessarily comprise a phosphorus reaction accelerant.

EP-A 672920 describes formaldehyde-free binding, impregnating or coating compositions which comprise at least one polyol and a polymer which is composed to an extent of 2% to 100% by weight of an ethylenically unsaturated acid or acid anhydride comonomer. The polyols are substituted triazine, triazinetrione, benzene or cyclohexyl derivatives, and the polyol radicals are always located in positions 1, 3, and 5 of the aforementioned rings. In spite of a high drying temperature, the wet tensile strengths obtained with these binders on glass fiber webs are low.

DE-A 2214450 describes a copolymer composed of 80% to 99% by weight of ethylene and 1% to 20% by weight of maleic anhydride. Together with a crosslinking agent, the copolymer is used in powder form or in dispersion in an aqueous medium for the purpose of surface coating. The crosslinking agent used is a polyalcohol which contains amino groups. In order to bring about crosslinking, however, heating must be carried out at up to 300° C.

U.S. Pat. No. 5,143,582 discloses the production of heat-resistant nonwoven-web materials using a thermosetting heat-resistant binder. The binder is formaldehyde-free and is obtained by mixing a crosslinker with a polymer containing carboxylic acid groups, carboxylic anhydride groups or carboxylic salt groups. The crosslinker is a β-hydroxy-alkylamide or a polymer or copolymer thereof. The polymer crosslinkable with the β-hydroxyalkylamide is synthesized, for example, from unsaturated monocarboxylic or dicarboxylic acids, salts of unsaturated monocarboxylic or dicarboxylic acids, or unsaturated anhydrides. Self-curing polymers are obtained by copolymerizing the β-hydroxyalkylamides with monomers comprising carboxyl groups.

It was an object of the present invention to provide an alternative formaldehyde-free binder system for fibrous or granular substrates.

The aqueous binder defined at the outset has accordingly been found.

Advantageously, however, the aqueous binder comprises an addition polymer A composed of

| | |
|---|---|
| 1% to 50% by weight | of at least one monomer A1, and |
| 50% to 99% by weight | of at least one monomer A2 |

and with particular advantage of

| | |
|---|---|
| 1% to 25% by weight | of at least one monomer A1, and |
| 75% to 99% by weight | of at least one monomer A2 |

in copolymerized form.

Monomers A1 contemplated are itaconic acid, itaconic anhydride and/or itaconic acid alkyl esters. By itaconic acid alkyl esters are meant not only the corresponding monoalkyl esters of itaconic acid, but also the dialkyl esters of itaconic acid, more particularly the corresponding C₁ to C₂₀ alkyl esters, preferably the mono- or di-methyl and -ethyl esters of itaconic acid. It will be appreciated that the corresponding salts of itaconic acid are also intended to be inventively comprised, such as, for example, the alkali metal salts, alkaline earth metal salts or ammonium salts, more particularly the corresponding sodium, potassium or ammonium salts. With particular advantage use is made of itaconic acid or itaconic anhydride, although itaconic acid is more particularly preferred.

The addition polymer A comprises 0.1% to 70%, preferably 1% to 50%, and with more particular preference 1% to 25%, by weight, of at least one monomer A1 in copolymerized form.

Monomers A2 contemplated are, in principle, all further ethylenically unsaturated monomers that are free-radically copolymerizable with the monomers A1, such as, for example, ethylenically unsaturated, more particularly α,β-monoethylenically unsaturated, C3 to C6, preferably C3 or C4 monocarboxylic or dicarboxylic acids, and also their water-soluble salts, more particularly their alkali metal salts or ammonium salts, such as, for example, acrylic acid, methacrylic acid, ethylacrylic acid, allylacetic acid, crotonic acid, vinylacetic acid, fumaric acid, maleic acid, maleic anhydride, methylmaleic acid, and also the ammonium, sodium or potassium salts of the aforementioned acids. Additionally monomers A2 are for example, vinylaromatic monomers, such as styrene, α-methylstyrene, o-chlorostyrene or vinyltoluenes, vinyl halides, such as vinyl chloride or vinylidene chloride, esters of vinyl alcohol and monocarboxylic acids having 1 to 18 C atoms, such as vinyl acetate, vinyl propionate, vinyl n-butyrate, vinyl laurate, and vinyl stearate, esters of α,β-monoethylenically unsaturated monocarboxylic and dicarboxylic acids preferably of 3 to 6 C atoms, such as, more particularly, acrylic acid, methacrylic acid, maleic acid, fumaric acid, and itaconic acid, with alkanols having generally 1 to 12, preferably 1 to 8, and more particularly 1 to 4 C atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate, nitriles of α,β-monoethylenically unsaturated carboxylic acids, such as acrylonitrile, methacrylonitrile, fumaronitrile, maleonitrile, and also C₄₋₈ conjugated dienes, such as 1,3-butadiene (butadiene) and isoprene. Further contemplated monomers A2, are those ethylenically unsaturated monomers which comprise either at least one sulfonic acid group and/or its corresponding anion, or at least one amino, amido, ureido or N-heterocyclic group and/or the ammonium derivatives thereof that are alkylated or protonated on the nitrogen. Mention may be made exemplarily of acrylamide and methacrylamide, and also vinylsulfonic acid, 2-acrylamido-2-methylpropanesulfonic acid, styrenesulfonic acid, and their water-soluble salts, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazolin-2-onyl)ethyl methacrylate.

Monomers A2 which typically enhance the internal strength of the films formed from a polymer matrix normally contain at least one epoxy group, at least one carbonyl group or at least two nonconjugated ethylenically unsaturated double bonds. Examples of such monomers are monomers containing two vinyl radicals, monomers containing two vinylidene radicals, and monomers containing two alkenyl radicals. Particularly advantageous in this context are the diesters of dihydric alcohols with α,β-monoethylenically unsaturated monocarboxylic acids, among which acrylic acid and methacrylic acid are preferred. Examples of such monomers containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, and ethylene glycol dimethacrylate, 1,2-propylene glycol dimethacrylate, 1,3-propylene glycol dimethacrylate, 1,3-butylene glycol dimethacrylate, and 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate.

The addition polymer A contains 30% to 99.9%, preferably 50% to 99%, and with more particular preference 75% to 99%, by weight, of at least one monomer A2 in copolymerized form.

Advantageously the addition polymer A comprises as monomer A2 at least one ethylenically unsaturated C3 to C4 monocarboxylic or dicarboxylic acid in copolymerized form. With particular advantage the addition polymer A comprises as monomer A2 exclusively at least one ethylenically unsaturated C3 to C4 monocarboxylic or dicarboxylic acid in copolymerized form. With more particular advantage the addition polymer A comprises exclusively acrylic acid and/or methacrylic acid, preferably exclusively acrylic acid, in copolymerized form.

The preparation of the polymers A is familiar in principle to the skilled worker and is accomplished more particularly by means of free-radically initiated solution polymerization, in water, for example, or in an organic solvent (see, for example, A. Echte, Handbuch der Technischen Polymerchemie, chapter 6, VCH, Weinheim, 1993 or B. Vollmert, Grundriss der Makromolekularen Chemie, volume 1, E. Vollmert Verlag, Karlsruhe, 1988; L. Kotzeva, J. Polym. Sci. A-27, 1989 (4), pages 1325ff; C. Erbil et al., Polymer 41, 2000, pages 1391ff; C. Yang, X. Lu Yun, J. Polym. Sci. 75(2), 2000, pages 327ff; M. Sen et al., Polymer 40(9), 1999, pages 913ff; F. Wang et al., Anal. Chem. 68, 1996, pages 2477ff; J. Velada et al., Macromol. Chem. and Phys. 196, 1995, pages 3171ff; J. M. Cowie, C. Haq, Br. Polym. J. 9, 1977, pages 241ff; J. Velada et al., Polymer Degradation and Stability 52, 1996, pages 273ff; A. Horta et al., Makromol. Chem., Rapid Commun. 8, 1987, pages 523ff; T. Hirano et al., J. Polym. Sci. A-38, 2000, pages 2487ff; B. E. Tate, Adv. Polymer Sci. 5, 1967, pages 214ff).

In accordance with the invention it is possible if appropriate to include in each case a portion or the total amount of the monomers A1 and/or A2 in the initial charge to the polymerization vessel. It is also possible, however, in each case to meter in the total amount or the respective remainder, if appropriate, of the monomers A1 and/or A2 during the polymerization reaction under polymerization conditions. The total amounts or the remainders, if appropriate, of monomers A1 and/or A2 may in that case be metered discontinuously, in one or more portions, or continuously, with constant or changing volume flows, to the polymerization vessel. Frequently at least a portion of the monomers A1 and/or A2, and, advantageously, of monomers A1 exclusively, in the polymerization medium, is included in the initial charge before the polymerization reaction is initiated.

The free-radically initiated solution polymerization of the monomers A1 and A2 takes place, frequently, in a protic or an aprotic organic solvent, with aprotic solvents being more particularly preferred. Suitable aprotic organic solvents include all organic solvents which under polymerization conditions comprise no ionizable proton in the molecule or have a pKa which is greater than that of water. Examples of such solvents are aromatic hydrocarbons, such as toluene, o-, m-, and p-xylene, and isomer mixtures, and also ethylbenzene, linear or cyclic aliphatic hydrocarbons, such as pentane, hexane, heptane, octane, nonane, dodecane, cyclohexane, cyclooctane, methylcyclohexane, and also mixtures of the stated hydrocarbons, and petroleum fractions which comprise no polymerizable monomers, or aliphatic or aromatic halogenated hydrocarbons, such as chloroform, carbon tetrachloride, hexachloroethane, dichloroethane, tetrachloroethane, chlorobenzene, and also liquid C1 and C2 hydrofluorochlorocarbons, aliphatic C2 to C5 nitriles, such as acetonitrile, propionitrile, butyronitrile or valeronitrile, linear or cyclic aliphatic C3 to C7 ketones, such as acetone, methyl ethyl ketone, methyl isobutyl ketone, 2- and 3-hexanone, 2-, 3-, and 4-heptanone, cyclopentanone, cyclohexanone, linear or cyclic aliphatic ethers, such as diisopropyl ether, 1,3- or 1,4-dioxane, tetrahydrofuran or ethylene glycol dimethyl ether, carbonates, such as diethyl carbonate, and also esters of aliphatic C1 to C5 carboxylic acids or aromatic carboxylic acids with aliphatic C1 to C5 alcohols, such as ethyl formate, n-propyl formate, isopropyl formate, n-butyl formate, isobutyl formate, tert-butyl formate, amyl formate, methyl acetate, ethyl acetate, n-propyl acetate, isopropyl acetate, n-butyl acetate, isobutyl acetate, tert-butyl acetate, amyl acetate, methyl propionate, ethyl propionate, n-propyl propionate, isopropyl propionate, n-butyl propionate, isobutyl propionate, tert-butyl propionate, amyl propionate, methyl butyrate, ethyl butyrate, n-propyl butyrate, isopropyl butyrate, n-butyl butyrate, isobutyl butyrate, tert-butyl butyrate, amyl butyrate, methyl valerate, ethyl valerate, n-propyl valerate, isopropyl valerate, n-butyl valerate, isobutyl valerate, tert-butyl valerate, amyl valerate, methyl benzoate or ethyl benzoate, and also lactones, such as butyrolactone, valerolactone or caprolactone.

One embodiment entails selecting those aprotic organic solvents in which the particular free-radical initiators used dissolve well. More particularly, use is made of those aprotic organic solvents in which not only the free-radical initiators but also the polymers A dissolve well. More particular preference is given to selecting those aprotic organic solvents which additionally can be separated in a simple way from the resulting polymer A solution, such as, for example, by distillation, inert-gas stripping and/or steam distillation. Preferred examples of such are esters of aliphatic C1 to C5 carboxylic acids or aromatic carboxylic acids with aliphatic C1 to C5 alcohols, such as ethyl formate, n-propyl formate, isopropyl formate, n-butyl formate, isobutyl formate, tert-butyl formate, amyl formate, methyl acetate, ethyl acetate, n-propyl acetate, isopropyl acetate, n-butyl acetate, isobutyl acetate, tert-butyl acetate, amyl acetate, methyl propionate, ethyl propionate, n-propyl propionate, isopropyl propionate, n-butyl propionate, isobutyl propionate, tert-butyl propionate, amyl propionate, methyl butyrate, ethyl butyrate, n-propyl butyrate, isopropyl butyrate, linear or cyclic aliphatic ethers, such as diisopropyl ether, 1,3- or 1,4-dioxane, tetrahydrofuran or ethylene glycol dimethyl ether, methyl glycol acetate, diethyl carbonate, linear or cyclic aliphatic C3 to C7 ketones, such as acetone, methyl ethyl ketone, methyl isobutyl ketone, 2- or 3-hexanone, 2-, 3- or 4-heptanone, cyclopentanone, or cyclohexanone. Particularly preferred solvents are the abovementioned esters of aliphatic C1 to C5 carboxylic acids or aromatic carboxylic acids with aliphatic C1 to C5 alcohols, but more particularly ethyl acetate and ethyl butyrate, and also C4 to C6 ketones, more particularly methyl ethyl ketone. It is advantageous if the solvent has a boiling point under atmospheric pressure (1 atm=1.013 bar absolute) ≦140° C., frequently ≦125° C., and more particularly ≦100° C., or forms a low-boiling azeotropic water/solvent mixture with water. It will be appreciated that a mixture of two or more solvents can also be used. With particular advantage, however, the free-radical polymerization of the monomers A1 and A2 takes place exclusively in water.

The amount of solvent in the preparation of the polymer A is 40 to 9900 parts, preferably 70 to 400 parts, and with more particular preference 80 to 200 parts by weight, based in each case on 100 parts by weight of total monomers.

In accordance with the invention it is possible to include, if appropriate, a portion or the entirety of solvent in the initial charge to the polymerization vessel. It is, however, also possible to meter in the entirety or, if appropriate, remainder of solvent during the polymerization reaction. In that case the entirety or, if appropriate, remainder of solvent can be metered into the polymerization vessel discontinuously, in one or more portions, or continuously, with constant or changing volume flows. Advantageously a portion of the solvent as polymerization medium is included in the initial charge to the polymerization vessel before the polymerization reaction is initiated, and the remainder is metered in together with the monomers A1 and/or A2 and the free-radical initiator during the polymerization reaction.

By initiation of the polymerization reaction is meant the start of the polymerization reaction of the monomers present in the liquid polymerization medium, after the formation of free radicals by the free-radical initiator. The initiation of the polymerization reaction may take place by addition of free-radical initiator to the liquid polymerization medium under polymerization conditions. An alternative possibility is to add a portion or the entirety of the free-radical initiator to the liquid polymerization medium comprising the monomer A1 and/or A2 under conditions not suitable for triggering a polymerization reaction, such as at low temperature, for example, and thereafter to bring about polymerization conditions in the liquid polymerization medium. By polymerization conditions are meant, generally, those temperatures and pressures under which the free-radically initiated polymerization reaction of the monomers A1 and A2 proceeds at a sufficient polymerization rate. They are dependant more particularly on the free-radical initiator used. The nature and amount of the free-radical initiator, the polymerization temperature, and the polymerization pressure are advantageously selected such that there are always sufficient initiating radicals available to initiate and maintain, respectively, the polymerization reaction. Suitability is possessed more particularly by all those free-radical initiators which under polymerization conditions have a half-life ≦4 hours, preferably ≦1 hour and advantageously ≦30 minutes.

Where the polymerization of the monomers A1 and A2 is carried out in an aqueous medium, use is made of what are known as water-soluble free-radical initiators, which the skilled worker typically uses in the case of free-radically initiated aqueous emulsion polymerization. If, on the other hand, the polymerization of the monomers is carried out in an organic solvent, then what are known as oil-soluble free-radical initiators are used, which the skilled worker typically uses in the case of free-radically initiated solution polymerization.

The free-radically initiated aqueous emulsion polymerization is triggered using what are known as water-soluble free-radical initiators. These may in principle be either peroxides or azo compounds. It will be appreciated that redox initiator systems are also suitable. Peroxides which can be used include, in principle, inorganic peroxides, such as hydrogen peroxide or peroxodisulfates, such as the mono- or di-alkali metal or -ammonium salts of peroxodisulfuric acid, such as its mono- and di-sodium, -potassium or -ammonium salts, or organic peroxides, such as alkyl hydroperoxides, examples being tert-butyl, p-menthyl or cumyl hydroperoxide, and also dialkyl or diaryl peroxides, such as di-tert-butyl peroxide or dicumyl peroxide. Azo compounds used are essentially 2,2′-azobis(isobutyronitrile), 2,2′-azobis(2,4-dimethylvaleronitrile), and 2,2′-azobis(amidinopropyl) dihydrochloride (AIBA, corresponding to V-50 from Wako Chemicals). Suitable oxidizing agents for redox initiator systems are essentially the abovementioned peroxides. As corresponding reducing agents it is possible to use sulfur compounds with a low oxidation state, such as alkali metal sulfites, examples being potassium sulfite and/or sodium sulfite, alkali metal hydrogen sulfites, examples being potassium and/or sodium hydrogen sulfite, alkali metal meta bisulfites, examples being potassium and/or sodium metabisulfite, formaldehyde sulfoxylates, examples being potassium and/or sodium formaldehyde sulfoxylate, alkali metal salts, especially potassium and/or sodium salts, of aliphatic sulfinic acids, and alkali metal hydrogen sulfides, such as potassium and/or sodium hydrogen sulfide, for example, salts of polyvalent metals, such as iron(II) sulfate, iron(II) ammonium sulfate, iron(II) phosphate, enediols, such as dihydroxymaleic acid, benzoin and/or ascorbic acid, and also reducing saccharides, such as sorbose, glucose, fructose and/or dihydroxyacetone.

Examples that may be mentioned of oil-soluble free-radical initiators include dialkyl and diaryl peroxides, such as di-tert-amyl peroxide, dicumyl peroxide, bis(tert-butylperoxyisopropyl)benzene, 2,5-bis(tert-butylperoxy)-2,5-dimethylhexane, tert-butylcumene peroxide, 2,5-bis(tert-butylperoxy)-2,5-dimethyl-3-hexene, 1,1-bis(tert-butylperoxy)-3,3,5-trimethylcyclohexane, 1,1-bis(tert-butylperoxy)cyclohexane, 2,2-bis(tert-butylperoxy)butane or di-tert-butyl peroxide, aliphatic and aromatic peroxyesters, such as cumyl peroxyneodecanoate, 2,4,4-trimethylpentyl 2-peroxyneodecanoate, tert-amyl peroxyneodecanoate, tert-butyl peroxyneodecanoate, tert-amyl peroxypivalate, tert-butyl peroxypivalate, tert-amyl peroxy-2-ethylhexanoate, tert-butyl peroxy-2-ethylhexanoate, tert-butyl peroxydiethylacetate, 1,4-bis(tert-butylperoxy)cyclohexane, tert-butyl peroxyisobutanoate, tert-butyl peroxy-3,5,5-trimethylhexanoate, tert-butyl peroxyacetate, tert-amyl peroxybenzoate or tert-butyl peroxybenzoate, dialkanoyl and dibenzoyl peroxides, such as diisobutanoyl peroxide, bis(3,5,5-trimethylhexanoyl) peroxide, dilauroyl peroxide, didecanoyl peroxide, 2,5-bis(2-ethylhexanoylperoxy)-2,5-dimethylhexane or dibenzoyl peroxide, and also peroxycarbonates, such as bis(4-tert-butylcyclohexyl) peroxydicarbonate, bis(2-ethylhexyl) peroxydicarbonate, di-tert-butyl peroxydicarbonate, diacetyl peroxydicarbonate, dimyristyl peroxydicarbonate, tert-butyl peroxyisopropyl carbonate or tert-butyl peroxy-2-ethylhexyl carbonate. Examples of readily oil-soluble azo initiators used include 2,2′-azobis(isobutyronitrile), 2,2′-azobis(2,4-dimethyl-valeronitrile) or 4,4′-azobis(4-cyanopentanoic acid).

The amount of free-radical initiator used is generally 0.01% to 10%, preferably 0.1% to 8%, and with more particular preference 0.5% to 5% by weight, based in each case on the total monomer amount.

In accordance with the invention it is possible to include, if appropriate, a portion or the entirety of free-radical initiator in the initial charge to the liquid polymerization medium. It is also possible, however, to meter in the entirety or the remainder, if appropriate, of free-radical initiator during the polymerization reaction under polymerization conditions. The entirety or the remainder, if appropriate, of free-radical initiator may in that case be metered into the liquid polymerization medium discontinuously, in one or more portions, or continuously, with constant or changing volume flows. With more particular advantage the free-radical initiator is metered during the polymerization reaction continuously, with constant volume flow—more particularly in the form of a solution of the free-radical initiator with the solvent used.

Polymer A advantageously has a weight-average molecular weight ≧1000 g/mol and ≦200 000 g/mol. It is advantageous if the weight-average molecular weight of polymer A is ≦150 000 g/mol or ≦100 000 g/mol. Advantageously polymer A has a weight-average molecular weight ≧3000 g/mol, with more particular advantage ≧10 000 g/mol, and with especial advantage ≧50 000 g/mol. With particular advantage the weight-average molecular weight is situated in the range ≧50000 and ≦150 000 g/mol. The setting of the weight-average molecular weight during the preparation of polymer A is familiar to the skilled worker and is advantageously accomplished by free-radically initiated aqueous solution polymerization in the presence of free-radical chain-transfer compounds, referred to as free-radical chain regulators. The determination of the weight-average molecular weight is also familiar to the skilled worker and is accomplished, for example, by means of gel permeation chromatography.

Examples of suitable free-radical chain regulators are organic compounds comprising sulfur in bonded form. They include, for example, mercapto compounds, such as mercaptoethanol, mercaptopropanol, mercaptobutanol, mercaptoacetic acid, mercaptopropionic acid, butyl mercaptan, and dodecyl mercaptan. Further free-radical chain regulators are familiar to the skilled worker. If the polymerization is carried out in the presence of free-radical chain regulators, it is common to use 0.01% to 10% by weight, based on the total monomer amount.

In accordance with the invention it is possible to include at least a portion of the free-radical chain regulator in the initial charge to the polymerization vessel and to add the remainder, if appropriate, to the polymerization vessel after the free-radical polymerization reaction has been initiated, that addition taking place discontinuously in one portion, discontinuously in two or more portions, and also continuously with constant or changing volume flows. Frequently the total amount of the free-radical chain regulator is added continuously, together with the monomers A1 and A2, to the polymerization vessel during the polymerization reaction.

By controlled variation of the nature and amount of the monomers A1 and A2 it is possible in accordance with the invention for the skilled worker to prepare polymers A which have a glass transition temperature or a melting point in the range from −60 to 270° C. Advantageously in accordance with the invention the glass transition temperature of the polymer A is ≧20° C. and ≦110° C., and preferably ≧20° C. and ≦110° C.

The glass transition temperature, T_{g}, is the limiting value of the glass transition temperature to which said temperature tends with increasing molecular weight, according to G. Kanig (Kolloid-Zeitschrift & Zeitschrift für Polymere, vol. 190, p. 1, equation 1). The glass transition temperature or melting point is determined by the DSC method (differential scanning calorimetry, 20 K/min, midpoint measurement, DIN 53765).

According to Fox (T. G. Fox, Bull. Am. Phys. Soc. 1956 [Ser. II] 1, page 123, and in accordance with Ullmann's Encyclopadie der technischen Chemie, vol. 19, page 18, 4th edition, Verlag Chemie, Weinheim, 1980) the glass transition temperature of copolymers with no more than low degrees of crosslinking is given in good approximation by:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², . . . T_{g}ⁿ are the glass transition temperatures of the polymers synthesized in each case only from one of the monomers 1, 2, . . . n, in degrees Kelvin. The T_{g} values for the homopolymers of the majority of monomers are known and are listed, for example, in Ullmann's Encyclopedia of Industrial Chemistry, 5th edition, vol. A21, page 169, VCH Weinheim, 1992; further sources of homopolymer glass transition temperatures include, for example, J. Brandrup, E. H. Immergut, Polymer Handbook, 1st ed., J. Wiley, New York 1966, 2nd ed. J. Wiley, New York 1975, and 3rd ed. J. Wiley, New York 1989.

The polymer A solutions obtained in accordance with the invention typically have polymer solids contents of ≧10% and ≦70%, frequently ≧20% and ≦65%, and often ≧35% and ≦55% by weight, based in each case on the corresponding polymer A solution.

Depending on the free-radical initiator used, the free-radically initiated polymerization takes place typically at temperatures in the range from 40 to 180° C., preferably from 50 to 150° C., and more particularly from 60 to 130° C. As soon as the temperature during the polymerization reaction is above the boiling point of the solvent and/or of one of the monomers A1 and A2, the polymerization is carried out advantageously under pressure (>1 atm absolute). The temperature and pressure conditions are familiar to the skilled worker or can be determined by him or her in a few routine experiments.

The polymers A can be prepared in the typical polymerization vessels. Examples of those used for this purpose include glass flasks (laboratory) or stirred tanks (industrial scale) equipped with an anchor, blade, impeller, cross-arm, MIG or multistage pulsed counter-current stirrer. In the case more particularly of polymerization in the presence of only small amounts of solvent, it may also be advantageous to carry out the polymerization in typical one-screw or two-screw (co-rotating or counter-rotating) kneader reactors, such as those, for example, from the company List or Buss SMS.

Where polymer A is prepared in an organic solvent, at least some of the organic solvent, advantageously ≧50% or ≧90% by weight, and, with more particular advantage, all of the organic solvent, is generally removed, and the polymer A is taken up in water, advantageously in deionized water. The corresponding methods are familiar to the skilled worker. Thus, for example, the switching of the solvent for water can be accomplished by distilling off at least some of the solvent, advantageously all of it, in one or more stages, at, for example, atmospheric pressure (1 atm absolute) or subatmospheric pressure (<1 atm absolute), and replacing it by water. Frequently it may be advantageous to remove the solvent from the solution by introducing steam and at the same time to replace it by water. This is more particularly the case when the organic solvent has a certain steam volatility.

The aqueous binder, in accordance with the invention, comprises not only the polymer A but also, as an active constituent, a polyol compound B which has at least 2 hydroxyl groups (polyol B). It is advantageous in this context to use those polyols B which are not volatile or only slightly volatile at the temperatures of drying and/or curing and which therefore have a correspondingly low vapor pressure.

The polyol B may in principle be a compound having a molecular weight ≦1000 g/mol or a polymeric compound having a molecular weight >1000 g/mol. Examples of polymeric compounds having at least 2 hydroxyl groups include polyvinyl alcohol, partly hydrolyzed polyvinyl acetate, homopolymers or copolymers of hydroxyalkyl acrylates or hydroxyalkyl methacrylates, such as hydroxyethyl acrylate or methacrylate or hydroxypropyl acrylate or methacrylate, for example. Examples of further polymeric polyols B are given in WO 97/45461, page 3, line 3 to page 14, line 33, among other publications.

Compounds contemplated as polyol B with a molecular weight ≦1000 g/mol include all those organic compounds which have at least 2 hydroxyl groups and a molecular weight ≦1000 g/mol. Mention may be made exemplarily of ethylene glycol, 1,2-propylene glycol, glycerol, 1,2- and 1,4-butanediol, pentaerythritol, trimethylolpropane, sorbitol, sucrose, glucose, 1,2-, 1,3-, and 1,4-dihydroxybenzene, 1,2,3-trihydroxybenzene, 1,2-, 1,3-, and 1,4-dihydroxycyclohexane, and also, preferably, alkanolamines, such as, for example compounds of the general formula I

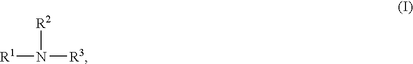

in which R¹ is an H atom, a C₁-C₁₀ alkyl group or a C₂-C₁₀ hydroxyalkyl group, and R² and R³ are a C₂-C₁₀ hydroxyalkyl group.

With particular preference R² and R³ independently of one another are a C₂-C₅ hydroxyalkyl group, and R¹ is an H atom, a C₁-C₅ alkyl group or a C₂-C₅ hydroxyalkyl group.

Compounds of the formula I include more particularly diethanolamine, triethanolamine, diisopropanolamine, triisopropanolamine, methyldiethanolamine, butyldiethanolamine and/or methyldiisopropanolamine.

Examples of further polyols B having a molecular weight ≦1000 g/mol are likewise found in WO 97/45461, page 3, line 3 to page 14, line 33.

The polyol B is preferably selected from the group comprising diethanolamine, triethanolamine, diisopropanolamine, triisopropanolamine, methyldiethanolamine, butyldiethanolamine and/or methyldiisopropanolamine, with triethanolamine being more particularly preferred.

For the aqueous binders which can be used in accordance with the invention, the polymer A and the polyol B are used preferably in a quantitative ratio to one another such that the weight ratio of polymer A to polyol B is 1:10 to 100:1, advantageously 1:5 to 50:1, and with more particular advantage 1:1 to 20:1.

With more particular advantage the amounts of polymer A and polyol B are chosen such that the ratio of the number of equivalents of carboxyl groups of the polymer A to the number of equivalents of hydroxyl groups of the polyol B is 100:1 to 1:5, preferably 50:1 to 1:3, and more preferably 10:1 to 1:2 (the anhydride groups in this case being counted as 2 carboxyl groups). With more particular preference the ratio of the number of equivalents of carboxyl groups of polymer A to the number of equivalents of hydroxyl groups of polyol B is 0.5 to 5.

The preparation of the aqueous binders which can be used in accordance with the invention is familiar to the skilled worker and is accomplished, for example, in a simple way by addition of the polyol B to the aqueous solution of the polymer A.

The aforementioned aqueous binders comprise preferably ≦1.5% by weight, frequently ≦1.0%, often ≦0.5%, frequently ≧0.1%, and often ≧0.3%, by weight, based on the sum of the total amounts of polymer A and polyol B (solid/solid), of a phosphorus reaction accelerant. Phosphorus reaction accelerants are disclosed in, for example, EP-A 583086 and EP-A 651088. They include, more particularly, alkali metal hypophosphites, phosphites, polyphosphates, and dihydrogen phosphates, polyphosphoric acid, hypophosphoric acid, phosphoric acid, alkylphosphinic acid, or oligomers and/or polymers of these salts and acids.

The aqueous binders of the invention, however, preferably comprise no phosphorus reaction accelerants or no amounts of a phosphorus compound that are active in accelerating the reaction. The binders of the invention may, however, comprise esterification catalysts familiar to the skilled worker, such as, for example, sulfuric acid or p-toluenesulfonic acid, or titanates or zirconates.

Furthermore, the aqueous binders of the invention may also comprise further, optional auxiliaries familiar to the skilled worker, such as, for example, what are known as thickeners, defoamers, neutralizing agents, buffer substances, preservatives, finely divided inert fillers, such as aluminum silicates, quartz, precipitated or fumed silica, light or heavy spar, talc or dolomite, coloring pigments, such as titanium white, zinc white or black iron oxide, adhesion promoters and/or flame retardants.

Where the aqueous binders of the invention are to be used as binders for mineral fibers and/or glass fibers or webs produced from them, advantageously ≧0.001% and ≦5% by weight, and with more particular advantage 24 0.05% and ≦2% by weight, based on the sum of the total amounts of polymer A and polyol B, of at least one silicon-containing organic compound (adhesion crosslinker) is added to the aqueous binders, such as, for example an alkoxysilane, such as methyltrimethoxysilane, n-propyltrimethoxysilane, n-octyltrimethoxysilane, n-decyltriethoxysilane, n-hexadecyltrimethoxysilane, dimethyldimethoxysilane, trimethylmethoxysilane, 3-acetoxypropyltrimethoxysilane, 3-aminopropyltrimethoxysilane, 3-aminopropyltriethoxysilane, 3-chloropropyltrimethoxysilane, 3-glycidyloxypropyl-trimethoxysilane, 3-mercaptopropyltrimethoxysilane and/or phenyltrimethoxysilane, with particular preference being given to functionalized alkoxysilanes, such as 3-acetoxypropyltrimethoxysilane, 3-aminopropyltrimethoxysilane, 3-aminopropyl-triethoxysilane, 3-chloropropyltrimethoxysilane, 3-glycidyloxypropyltrimethoxysilane and/or 3-mercaptopropyltrimethoxysilane.

The aqueous binders which can be used in accordance with the invention typically have solids contents (formed from the sum of the total amount of polymer A and polyol B reckoned as solids) of ≧1% and ≦70%, frequently ≧5% and ≦65%, and often ≧10% and ≦55%, by weight, based in each case on the aqueous binder.

The aqueous binders which can be used in accordance with the invention typically have pH values (measured at 23° C.; diluted with deionized water to a solids content of 10% by weight) in the range of ≧1 and ≦10, advantageously ≧2 and ≦6, and with more particular advantage ≧3 and ≦5. The pH in this case may be set using all of the basic compounds that are familiar to the skilled worker. It is advantageous, however, to use those basic compounds which are not volatile at the temperatures during drying and/or curing, such as sodium hydroxide, potassium hydroxide or sodium carbonate, for example.

The abovementioned aqueous binders are advantageously suitable for use as binders for fibrous and granular substrates. With advantage, therefore, the aqueous binders stated can be used in the production of shaped articles from fibrous and granular substrates.

Fibrous and/or granular substrates are familiar to the skilled worker. Examples include wood chips, wood fibers, cellulose fibers, textile fibers, plastics fibers, glass fibers, mineral fibers or natural fibers such as jute, flax, hemp or sisal, but also cork chips or sand or the abovementioned finely divided inert fillers and also other organic or inorganic, natural and/or synthetic, fibrous and/or granular compounds whose longest extent, in the case of granular substrates, is ≦10 mm, preferably ≦5 mm, and more particularly ≦2 mm. It will be appreciated that the term “substrate” is also intended to comprise the fiber webs obtainable from fibers, such as, for example, those known as needled (mechanically consolidated) fiber webs or fiber webs chemically bound for example with melamine/formaldehyde resins or polyvinyl alcohol. With more particular advantage the aqueous binder of the invention is suitable as a formaldehyde-free binder system for the aforementioned fibers and for fiber webs formed from them. The process for producing a shaped article from a fibrous and/or granular substrate and the aforementioned aqueous binder is advantageously performed by applying the aqueous binder of the invention to the granular and/or fibrous substrates and/or drenching the granular and/or fibrous substrates with the aqueous binder of the invention, if appropriate shaping the granular and/or fibrous substrates impregnated with the aqueous binder, and then subjecting the impregnated granular and/or fibrous substrates to a thermal treatment step at a temperature ≧130° C.

The impregnation of the fibrous and/or granular substrates with the aqueous binder of the invention is generally accomplished by applying the aforementioned aqueous binder uniformly to the surface of the fibrous and/or granular substrates. The amount of aqueous binder in this case is chosen such that ≧0.1 g and ≦100 g, preferably ≧1 g and ≦50 g, and with more particular preference ≧5 g and ≦30 g of binder, formed from the sum of the total amount of polymer A and polyol B (reckoned as solids), are used per 100 g of fibrous and/or granular substrate. The impregnation of the fibrous and/or granular substrates is familiar to the skilled worker and takes place, for example, by drenching or by spraying of the fibrous and/or granular substrates.

Following impregnation, the fibrous and/or granular substrate is brought if appropriate into the desired form, by means, for example, of introduction into a heatable press or mold. Subsequently the shaped impregnated fibrous and/or granular substrate is dried and cured in a manner familiar to the skilled worker.

Frequently the drying and/or curing of the impregnated fibrous and/or granular substrate, which if appropriate has been brought into shape, takes place in two temperature stages, the drying stage taking place at a temperature <130° C., preferably ≧20° C. and ≦120° C., and with more particular preference ≧40 and ≦100° C., and the curing stage taking place at a temperature of ≧130° C., preferably ≧150 and ≦250° C. or ≧160° C. and ≦220° C., and with more particular preference ≧170° C. and ≦210° C.

The drying stage in this case takes place advantageously such that drying at a temperature ≦100° C. is carried out until the shaped, impregnated fibrous and/or granular substrate, which frequently still does not have its ultimate shape (and is referred to as a semifinished product), has a residual moisture content ≦15%, preferably ≦12%, and with more particular preference ≦10% by weight. This residual moisture content is determined by first weighing the resulting semifinished product at room temperature, then drying it at 130° C. for 2 minutes, and subsequently cooling it and reweighing it at room temperature. In this case the residual moisture content corresponds to the difference in weight of the semifinished product before and after the drying operation at 130° C., relative to the weight of the semifinished product before the drying operation, multiplied by a factor of 100.

The semifinished product obtained in this way is still deformable after heating to a temperature ≧100° C., and at that temperature can be brought into the ultimate shape of the desired shaped article.

The subsequent curing stage takes place advantageously such that the semifinished product is heated at a temperature ≧130° C. until it has a residual moisture content ≦1%, preferably ≦0.5%, and with more particular preference ≦0.1% by weight, the binder curing as a consequence of a chemical esterification reaction.

Frequently the shaped articles are produced by bringing the semifinished product into its ultimate shape in a shaping press, in the aforementioned temperature ranges, and subsequently curing it.

It will be appreciated, however, that it is also possible for the drying stage and the curing stage of the shaped articles to take place in one workstep, in a shaping press, for example.

The shaped articles obtainable by the process of the invention have advantageous properties, more particularly an equal or improved tensile strength as compared with the prior-art shaped articles.

The invention is elucidated with reference to the following nonlimiting examples.

### EXAMPLES

### A. Preparation of the Polymers A

A 2 l four-necked flask equipped with an anchor stirrer, reflux condenser, and two metering devices was charged at 20 to 25° C. (room temperature) with 340 g of deionized water, 5.3 mg of iron(II) sulfate heptahydrate and X g of itaconic acid (IA) under a nitrogen atmosphere. Subsequently the initial-charge solution was heated to 100° C. with stirring. After it had reached that temperature, the initiator feed, consisting of a homogenous solution of 18.0 g of sodium persulfate and 382 g of deionized water, was started and was metered into the initial charge with a constant volume flow over the course of 4 hours. 5 minutes after the start of the initiator feed the monomer feed, consisting of a homogeneous solution of 420 g of deionized water and Y g of acrylic acid (AA), was started and was metered into the aqueous polymerization mixture with a constant volume flow over the course of 3 hours. After the end of the monomer feed the polymerization mixture was allowed to continue reaction at polymerization temperature for 2 hours, after which the clear polymer solution obtained was cooled to room temperature. The amounts of IA and AA used in preparing the polymers A are listed in table 1.

### B. Preparation of the Comparative Polymers C

The preparation of the comparative polymers C was the same as for the preparation of the polymers A, with the difference that maleic anhydride (MAn) was used instead of IA, or neither IA nor MAn was used. The amounts of MAn and AA used in preparing the comparative polymers C are likewise listed in table 1.

TABLE 1
The monomer amounts used in preparing the polymers A and the
comparative polymers C

| Polymer | X g IA | Y g AA | X g MAn |
|---|---|---|---|
| A1 | 150 | 450 | — |
| A2 | 60 | 540 | — |
| A3 | 30 | 570 | — |
| C1 | — | 600 | — |
| C2 | — | 450 | 127 ( [symbol] 150 MA) |
| C3 | — | 540 | 51 ( [symbol] 60 MA) |
| C4 | — | 570 | 25.4 ( [symbol] 30 MA) |

### C. Preparation of the Aqueous Binders

The polymer solutions obtained under sections A and B above were admixed at room temperature and with stirring with 30 parts by weight or 15 parts by weight of triethanolamine (TEA), based on 100 parts by weight of the monomers used to prepare the polymers A1 to A3. In the case of the comparative polymers C1 to C4, likewise 30 parts or 15 parts by weight of TEA were added, based on 100 parts by weight of the monomers used in the preparation, but taking account, when calculating the 100 parts by weight of monomers, of the amounts of MAn in the form of the corresponding amounts of maleic acid (MA). Furthermore, 0.3% by weight of 3-aminopropyl-triethoxysilane, based on 100 parts by weight of the monomers used in the preparation, was added in each case, with stirring, to the aqueous binder solutions obtained. Subsequently the corresponding aqueous binders were diluted with deionized water to a solids content of 4% by weight, based on the total amounts of monomers IA, AA, MA, and TEA.

### D. Performance Investigations

Glass fiber webs from Whatman, GF/A No. 1820-915, with a basis weight of 54 g/m², were used.

For impregnation the glass fiber webs were passed in longitudinal direction via a continuous PES sieve belt with a belt running speed of 60 cm per minute through the aforementioned 4% strength by weight aqueous binder liquors. Through subsequent suction removal of the aqueous binder, the wet add-on was set at 270 g/m² (corresponding to 10.8 g/m² binder, reckoned as solid). The impregnated glass fiber webs obtained in this way were dried/cured in a Mathis oven, on a plastic net support, either at 180° C. for 3 minutes or at 200° C. for 3 minutes, with the maximum hot-air flow. After the webs had been cooled to room temperature, test strips measuring 240×50 mm were cut in the longitudinal direction of the fiber. The test strips obtained were then stored in a climate chamber at 23° C. and 50% relative humidity for 24 hours. The glass fiber web test strips obtained are referred to below, as a function of the polymer solution used for the corresponding aqueous binder, as test strips A1 to A3 and C1 to C4.

### Determination of the Tensile Strength at 23° C.

The tensile strength was determined on a Zwick-Roell Z005 tensile testing machine. The test strips A1 to A3 and C1 to C4 were introduced vertically into a clamping device such that the free clamped-in length was 200 mm. Subsequently the clamped-in test strips were pulled apart in opposite directions at a speed of 25 mm per minute until the test strips tore. The higher the force needed to tear the test strips, the better the evaluation of the corresponding tensile strength. 5 measurements were carried out in each case. The figures reported in Table 2 represent in each case the average of these measurements.

TABLE 2
compilation of the tensile force results [figures in N/50 mm]

| | |
|---|---|
| Parts by weight | Parts by weight |
| of TEA | of TEA |

| | | | |
|---|---|---|---|
| 30 | 15 | 30 | 15 |

| | | |
|---|---|---|
| Test strip | Curing at 180° C. | Curing at 200° C. |

| | | | | |
|---|---|---|---|---|
| A1 | 112 | 114 | 113 | 122 |
| A2 | 112 | 125 | 107 | 116 |
| A3 | 127 | 125 | 114 | 123 |
| C1 | 92 | 88 | 101 | 96 |
| C2 | 111 | 112 | 111 | 118 |
| C3 | 111 | 108 | 105 | 112 |
| C4 | 105 | 104 | 105 | 107 |

From the results it is clearly apparent that the test strips obtained using the aqueous binders of the invention exhibit an equal or improved tensile strength behavior as compared with the aqueous binders used in accordance with the prior art.

1. An aqueous binder for fibrous and/or granular substrates comprising as active constituents
a) an addition polymer A composed of

| | |
|---|---|
| 0.1% to 70% by weight | of itaconic acid, itaconic anhydride and/or |
| | itaconic acid alkyl ester (monomer A1), and |
| 30% to 99.9% by weight | of at least one further ethylenically unsaturated |
| | monomer (monomer A2) free-radically |
| | copolymerizable with the monomer A1 |

in copolymerized form, the monomers A1 and A2 adding up to 100% by weight (total monomer amount), and
b) a polyol B having at least 2 hydroxyl groups.

2. The aqueous binder according to claim 1, comprising an addition polymer A composed of

| | |
|---|---|
| 1% to 50% by weight | of at least one monomer A1, and |
| 50% to 99% by weight | of at least one monomer A2. |

3. The aqueous binder according to claim 1 or 2, comprising an addition polymer A composed of

| | |
|---|---|
| 1% to 25% by weight | of at least one monomer A1, and |
| 75% to 99% by weight | of at least one monomer A2. |

4. The aqueous binder according to any one of claims 1 to 3, the addition polymer A comprising as monomer A2 at least one ethylenically unsaturated C3 to C4 monocarboxylic or dicarboxylic acid in copolymerized form.

5. The aqueous binder according to any one of claims 1 to 4, the addition polymer A comprising as monomer A2 exclusively at least one ethylenically unsaturated C3 to C4 monocarboxylic or dicarboxylic acid in copolymerized form.

6. The aqueous binder according to any one of claims 1 to 5, the addition polymer A comprising as monomer A2 exclusively acrylic acid and/or methacrylic acid in copolymerized form.

7. The aqueous binder according to any one of claims 1 to 6, the polyol B having a molecular weight ≦1000 g/mol.

8. The aqueous binder according to any one of claims 1 to 7, the polyol B being an alkanolamine.

9. The aqueous binder according to any one of claims 1 to 8, the polyol B being triethanolamine.

10. The aqueous binder according to any one of claims 1 to 9, the equivalence ratio of the carboxyl groups of the polymer A to the hydroxyl groups of the polyol B being 0.5 to 5.

11. The aqueous binder according to any one of claims 1 to 10, the solids content, formed from the total amount of polymer A and polyol B, being ≧1% and ≦70% by weight.

12. The use of an aqueous binder according to any one of claims 1 to 11 for producing shaped articles from granular and/or fibrous substrates.

13. A process for producing a shaped article from granular and/or fibrous substrates, which comprises applying an aqueous binder according to any one of claims 1 to 11 to the granular and/or fibrous substrates, if appropriate shaping the granular and/or fibrous substrates treated with the aqueous binder, and then subjecting the treated granular and/or fibrous substrates to a thermal treatment step at a temperature ≧130° C.

14. The process according to claim 13, wherein ≧1 g and ≦50 g of binder (calculated as the sum of the total amounts of polymer A and polyol B [solid/solid]) are used per 100 g of granular and/or fibrous substrate.

15. The process according to claim 13 or 14, wherein a mechanically consolidated or chemically bound fiber web is used as granular and/or fibrous substrate.

16. A shaped article obtainable by a process according to any one of claims 13 to 15.
